(19) United States
(12) Patent Application Publication
(10) Pub. No.: US 2020/0265654 A1
(43) Pub. Date: Aug. 20, 2020

(54) VEHICLE DISTANCE-TO-EMPTY PREDICTION SYSTEM

(71) Applicant: Ford Global Technologies, LLC, Dearborn, MI (US)

(72) Inventors: Jimmy KAPADIA, Ottawa Hills, OH (US); Daniel Lewis BOSTON, Dearborn, MI (US); Anne GOERING, Livonia, MI (US)

(21) Appl. No.: 16/275,644

(22) Filed: Feb. 14, 2019

(51) Int. Cl. G07C 5/00; G06N 5/04; B60W 40/13; B60L 58/12; G07C 5/06

(52) U.S. Cl. CPC G07C 5/004; G06N 5/048; B60W 40/13; B60Y 2200/91; G07C 5/06; B60W 2530/10; B60L 58/12

(57) ABSTRACT

A vehicle includes an electric machine, a battery, an interface, and a controller. The electric machine is configured to propel the vehicle. The battery is configured to provide electrical power to the electric machine. The controller is programmed to, display a distance-to-empty prediction on the interface. The controller is also programmed to, in response to detecting a change in a cargo load on the vehicle, adjust the distance-to-empty prediction based on shared data from other vehicles.

### TECHNICAL FIELD

The present disclosure relates to distance-to-empty prediction systems for vehicles.

### BACKGROUND

Vehicles may include an interface that displays the remaining distance a vehicle may travel until the vehicle is predicted to consume the remaining fuel that the vehicle is currently storing.

### SUMMARY

A vehicle includes an electric machine, a battery, an interface, and a controller. The electric machine is configured to propel the vehicle. The battery is configured to provide electrical power to the electric machine. The controller is programmed to, display a distance-to-empty prediction on the interface. The controller is also programmed to, in response to detecting a change in a cargo load on the vehicle, adjust the distance-to-empty prediction based on shared data from other vehicles.

A vehicle controller includes an input that is configured to received signals indicative of a cargo load that has been placed onto the vehicle, an output that is configured to transmit a signal indicative of a distance-to-empty prediction, and control logic that is programmed to, in response to detecting a change in the cargo load on the vehicle, adjust the distance-to-empty prediction based on shared data from other vehicles.

A method of adjusting a distance-to-empty prediction of an electric vehicle includes displaying a distance-to-empty prediction on an interface, and in response to detecting a change in a cargo load on the vehicle, adjusting the distance-to-empty prediction based on shared data from other vehicles.

### BRIEF DESCRIPTION OF THE DRAWINGS

FIG. 1 shows an illustrative vehicle computing system;

FIG. 2 is a schematic illustration of a representative powertrain of an electric vehicle;

FIG. 3 is a flowchart illustrating a method of adjusting and updating a distance-to-empty prediction; and

FIG. 4 is a graph illustrating a percentage adjustment to the distance-to-empty prediction relative to the weight or a load on the vehicle.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

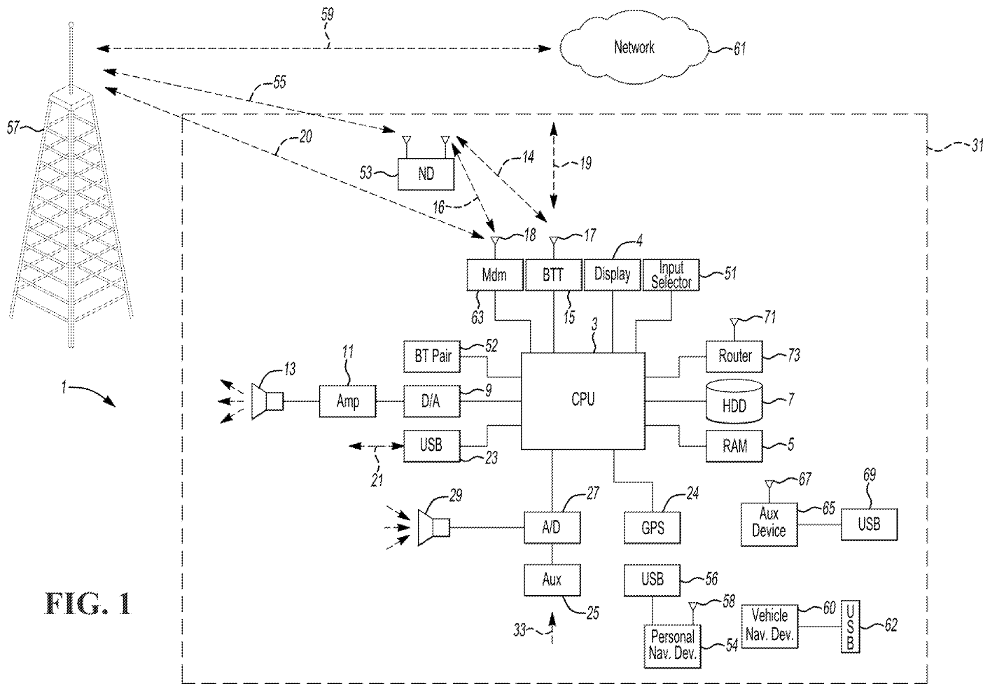

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a central processing unit (CPU) 3, which may also be referred to as a controller or process, controls at least some portion of the operation of the vehicle-based computing system. It should be noted that a CPU may specifically refer to the portion of the controller that carries out the instructions of a computer program. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as personal navigation device (PND) 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an application programming interface (API) to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard global positioning system (GPS) device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU 3 could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

As previously noted, in any given situation, a driver may need/want a varied set of controls or inputs based on current conditions. For example, upon initially setting out in a vehicle, the driver may wish to set a radio station or climate. On days when the climate is reasonable (e.g., the interior temperature is within an observed, preferred range), the driver may first change the radio before performing any climate settings. On other days, where the interior temperature is above or below a preferred range, the driver may first set the climate before changing the radio. Even in this fairly simple example, where the vehicle is not yet moving, the driver may have to navigate through one or more menus to obtain a desired control. Since different actions are taken under different conditions when the driver enters the vehicle, there cannot be a simple default to “always display climate” or “always display radio.” Or rather, one of these could be a default, but at least some of the time defaulting to a particular option would not result in a display appropriate for the immediate desires of the driver.

Providing a driver with a “smart” vehicle display can reduce driver frustration, save the driver time, and increase the driver's feeling that the vehicle is in touch with modern technology. Further, in a driving situation, a driver may simply forego use of certain vehicle features that would improve the driving experience, because the driver does not know about the features, or because the driver is too busy driving to navigate to a particular feature.

The illustrative examples present solutions based on a determination of driver intent. Driver intent can be instantaneously determined through an algorithm that uses neural networks, for example. Illustrative inputs to such an algorithm include: (i) driver physiological measures that include, but are not restricted to, heart rate, respiration rate, evoked cortical potentials, galvanic skin response, and electromyography; (ii) driver behavior parameters as determined from on-board diagnostics (OBD) data and include, but are not restricted to, brake pedal activation, accelerator activation, steering wheel activation; (iii) observable inputs in reference to the driver, such as, but not limited to, visual search and scan activity, frequency and duration of gaze and view of the side and rear-view mirrors, instrument panel and dashboard; and (iv) camera view of the path of travel and of the sides of the driven vehicle. An exemplary algorithm uses Markov analyses of all of the mentioned variables to determine, as output, the immediate intent of the driver (e.g., change lane of travel, accelerate vehicle, slow down, use a telematics system to contact someone, etc.).

These and other context variables can be measured by in-vehicle sensors or driver devices/sensors worn/carried and in contact or connection with a vehicle. Other context variables can be provided to a vehicle through a wireless connection with a remote network.

Based on the determined intent, a virtual control and display panel that relates to the determined intent can be made available to the driver or other occupants. This can be automatically presented as an activatable option, or the display can simply be dynamically adjusted. The automatic presentation of certain displays and controls can be contingent on, for example, preferred driver settings and/or a degree of confidence associated with a particular prediction.

Study has shown, for example, that driver intent to make a lane change can be foreseen from an analysis of heart rate data. Similarly, in at least one illustrative example, driver intent to invoke any feature/function can be determined and momentarily assigned to a re-configurable steering wheel with an embedded circumferential ring. When an ‘intent’ is sensed by the neural network based algorithm (i.e., when conditions dictate that a likely driver action is upcoming), and the driver interacts with (such as taps) the circumferential ring on the steering-wheel, a related display is provided as confirmatory feedback and the intended action is completed through the appropriate vehicle system. As noted, based on settings and a confidence level, the display can simply be automatically changed, without waiting for approval. (For example, the driver could have preconfigured automatic display change when traffic volume is high, or when a confidence is above N percent, or for certain features, etc.).

As will be appreciated, the various vehicle communication modules can be used, alone or in conjunction with each other, to facilitate V2X (vehicle to anything) communication. This can include, for example, vehicle to vehicle, vehicle to cloud, vehicle to infrastructure, etc. The particular mode of communication, data-relay and data-source can be chosen in accordance with an understanding of the illustrative embodiments and a particular chosen implementation. Furthermore, other vehicles may upload data to the network 61 in any manner as described in FIG. 1, which may be then downloaded by vehicle 31.

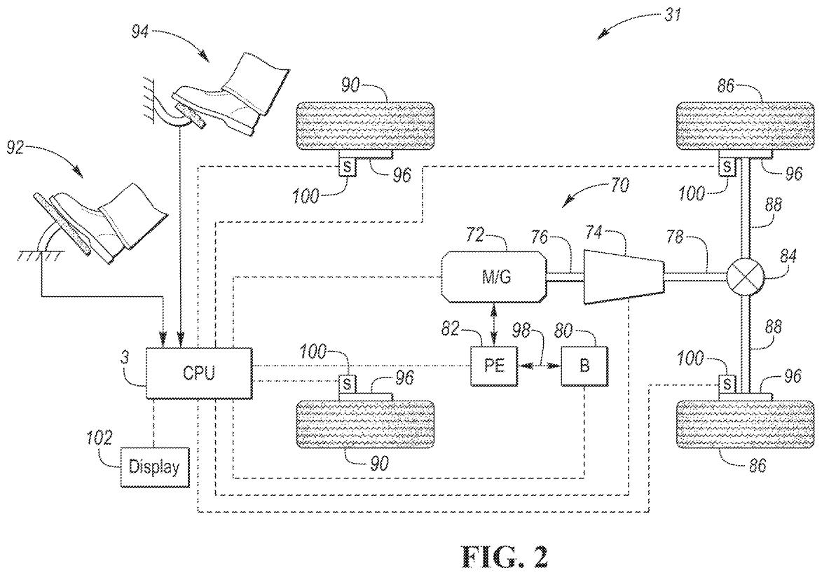

Referring to FIG. 2, a schematic diagram of the vehicle 31, which is an electric vehicle, is illustrated according to an embodiment of the present disclosure. FIG. 2 illustrates representative relationships among the components. Physical placement and orientation of the components within the vehicle may vary. The electric vehicle 31 includes a powertrain 70. The powertrain 70 includes an electric machine such as an electric motor/generator (M/G) 72 that drives a transmission (or gearbox) 74. More specifically, the M/G 72 may be rotatably connected to an input shaft 76 of the transmission 74. The transmission 74 may be placed in PRNDSL (park, reverse, neutral, drive, sport, low) via a transmission range selector (not shown). The transmission 74 may have a fixed gearing relationship that provides a single gear ratio between the input shaft 76 and an output shaft 78 of the transmission 74. A torque converter (not shown) or a launch clutch (not shown) may be disposed between the M/G 72 and the transmission 74. Alternatively, the transmission 74 may be a multiple step-ratio automatic transmission. An associated traction battery 80 is configured to deliver electrical power to or receive electrical power from the M/G 72.

The M/G 72 is a drive source for the electric vehicle 31 that is configured to propel the electric vehicle 31. The M/G 72 may be implemented by any one of a plurality of types of electric machines. For example, M/G 72 may be a permanent magnet synchronous motor. Power electronics 82 condition direct current (DC) power provided by the battery 80 to the requirements of the M/G 72, as will be described below. For example, the power electronics 82 may provide three phase alternating current (AC) to the M/G 72.

If the transmission 74 is a multiple step-ratio automatic transmission, the transmission 74 may include gear sets (not shown) that are selectively placed in different gear ratios by selective engagement of friction elements such as clutches and brakes (not shown) to establish the desired multiple discrete or step drive ratios. The friction elements are controllable through a shift schedule that connects and disconnects certain elements of the gear sets to control the ratio between the transmission output shaft 78 and the transmission input shaft 76. The transmission 74 is automatically shifted from one ratio to another based on various vehicle and ambient operating conditions by an associated controller, such as a powertrain control unit (PCU), which may include controller 3. Power and torque from the M/G 72 may be delivered to and received by transmission 74. The transmission 74 then provides powertrain output power and torque to output shaft 78.

It should be understood that the hydraulically controlled transmission 74, which may be coupled with a torque converter (not shown), is but one example of a gearbox or transmission arrangement; any multiple ratio gearbox that accepts input torque(s) from a power source (e.g., M/G 72) and then provides torque to an output shaft (e.g., output shaft 78) at the different ratios is acceptable for use with embodiments of the present disclosure. For example, the transmission 74 may be implemented by an automated mechanical (or manual) transmission (AMT) that includes one or more servo motors to translate/rotate shift forks along a shift rail to select a desired gear ratio. As generally understood by those of ordinary skill in the art, an AMT may be used in applications with higher torque requirements, for example.

As shown in the representative embodiment of FIG. 2, the output shaft 78 is connected to a differential 84. The differential 84 drives a pair of drive wheels 86 via respective axles 88 that are connected to the differential 84. The drive wheels 86 may refer the rear wheels of the vehicle 31. The differential 84 transmits approximately equal torque to each drive wheel 86 while permitting slight speed differences such as when the vehicle turns a corner. Different types of differentials or similar devices may be used to distribute torque from the powertrain to one or more wheels. In some applications, torque distribution may vary depending on the particular operating mode or condition, for example. The vehicle 31 also includes second pair of wheels 90. The second pair of wheels 90 may refer to the front wheels of the vehicle 31.

The powertrain 70 further includes an associated controller, such as the powertrain control unit (PCU), which may include controller 3. While illustrated as one controller, the controller 3 may be part of a larger control system and may be controlled by various other controllers throughout the vehicle 31, such as a vehicle system controller (VSC). It should therefore be understood that the controller 3 and one or more other controllers can collectively be referred to as a “controller” that controls various actuators in response to signals from various sensors to control functions such as operating the M/G 72 to provide wheel torque or charge the battery 80, select or schedule transmission shifts, etc. Controller 3 may include a microprocessor or central processing unit (CPU) that is in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller in controlling the engine or vehicle.

The controller 3 communicates with various vehicle sensors and actuators via an input/output (I/O) interface (including input and output channels) that may be implemented as a single integrated interface that provides various raw data or signal conditioning, processing, and/or conversion, short-circuit protection, and the like. Alternatively, one or more dedicated hardware or firmware chips may be used to condition and process particular signals before being supplied to the CPU. As generally illustrated in the representative embodiment of FIG. 2, controller 3 may communicate signals to and/or receive signals from the M/G 72, battery 80, transmission 74, power electronics 82, and any another component of the powertrain 70 that may be included, but is not shown in FIG. 2 (e.g., a launch clutch that may be disposed between the M/G 72 and the transmission 74. Although not explicitly illustrated, those of ordinary skill in the art will recognize various functions or components that may be controlled by controller 3 within each of the subsystems identified above. Representative examples of parameters, systems, and/or components that may be directly or indirectly actuated using control logic and/or algorithms executed by the controller 3 include front-end accessory drive (FEAD) components such as an alternator, air conditioning compressor, battery charging or discharging, regenerative braking, M/G 74 operation, clutch pressures for the transmission gearbox 74 or any other clutch that is part of the powertrain 70, and the like. Sensors communicating input through the I/O interface may be used to indicate wheel speeds (WS1, WS2), vehicle speed (VSS), coolant temperature (ECT), accelerator pedal position (PPS), ignition switch position (IGN), ambient air temperature, transmission gear, ratio, or mode, transmission oil temperature (TOT), transmission input and output speed, deceleration or shift mode (MDE), battery temperature, voltage, current, or state of charge (SOC) for example.

Control logic or functions performed by controller 3 may be represented by flow charts or similar diagrams in one or more figures. These figures provide representative control strategies and/or logic that may be implemented using one or more processing strategies such as event-driven, interrupt-driven, multi-tasking, multi-threading, and the like. As such, various steps or functions illustrated may be performed in the sequence illustrated, in parallel, or in some cases omitted. Although not always explicitly illustrated, one of ordinary skill in the art will recognize that one or more of the illustrated steps or functions may be repeatedly performed depending upon the particular processing strategy being used. Similarly, the order of processing is not necessarily required to achieve the features and advantages described herein, but is provided for ease of illustration and description. The control logic may be implemented primarily in software executed by a microprocessor-based vehicle and/or powertrain controller, such as controller 3. Of course, the control logic may be implemented in software, hardware, or a combination of software and hardware in one or more controllers depending upon the particular application. When implemented in software, the control logic may be provided in one or more computer-readable storage devices or media having stored data representing code or instructions executed by a computer to control the vehicle or its subsystems. The computer-readable storage devices or media may include one or more of a number of known physical devices which utilize electric, magnetic, and/or optical storage to keep executable instructions and associated calibration information, operating variables, and the like.

The controller 3 may be configured to receive various states or conditions of the various vehicle components illustrated in FIG. 2 via electrical signals. The electrical signals may be delivered to the controller 3 from the various components via input channels. Additionally, the electrical signals received from the various components may be indicative of a request or a command to change or alter a state of one or more of the respective components of the vehicle 31. The controller 3 includes output channels that are configured to deliver requests or commands (via electrical signals) to the various vehicle components. The controller 3 includes control logic and/or algorithms that are configured to generate the requests or commands delivered through the output channels based on the requests, commands, conditions, or states of the various vehicle components.

The input channels and output channels are illustrated as dotted lines in FIG. 2 or any of the connections with the controller 3 illustrated in FIG. 1. It should be understood that a single dotted line may be representative of both an input channel and an output channel into or out of a single element. Furthermore, an output channel out of one element may operate as an input channel to another element and vice versa.

An accelerator pedal 92 is used by the driver of the vehicle 31 to provide a demanded torque, power, or drive command to the powertrain 70 (or more specifically M/G 72) to propel the vehicle 31. In general, depressing and releasing the accelerator pedal 92 generates an accelerator pedal position signal that may be interpreted by the controller 3 as a demand for increased power or decreased power, respectively. A brake pedal 94 is also used by the driver of the vehicle 31 to provide a demanded braking torque to slow the vehicle 31. In general, depressing and releasing the brake pedal 94 generates a brake pedal position signal that may be interpreted by the controller 3 as a demand to decrease the vehicle speed. Based upon inputs from the accelerator pedal 92 and brake pedal 94, the controller 3 commands the torque and/or power to the M/G 72, and friction brakes 96. The controller 3 also controls the timing of gear shifts within the transmission 74.

The M/G 72 may act as a motor and provide a driving force for the powertrain 70. To drive the vehicle 31 with the M/G 72 the traction battery 80 transmits stored electrical energy through wiring 98 to the power electronics 82 that may include an inverter, for example. The power electronics 82 convert DC voltage from the battery 80 into AC voltage to be used by the M/G 72. The controller 3 commands the power electronics 82 to convert voltage from the battery 80 to an AC voltage provided to the M/G 72 to provide positive or negative torque to the input shaft 78.

The M/G 72 may also act as a generator and convert kinetic energy from the powertrain 70 into electric energy to be stored in the battery 80. More specifically, the M/G 72 may act as a generator during times of regenerative braking in which torque and rotational (or kinetic) energy from the spinning wheels 86 is transferred back through the transmission 74 and is converted into electrical energy for storage in the battery 80.

The vehicle 31 may include sensors 100 that are disposed proximate to each of the rear wheels 86 and each of the front wheels 90 of the vehicle 31. The sensors 100 are configured to detect any weight or cargo load that has been placed upon the vehicle 31. The sensors 100 may more specifically be disposed within shock-absorbers that are disposed proximate to each of the rear wheels 86 and each of the front wheels 90, and may be configured to measure the weight or load that has been added to the vehicle 31 by measuring the displacement of the shock-absorbers. The controller 3 may be programmed to distinguishing between whether the vehicle 31 itself is being loaded with cargo or whether the extra load vehicle 31 is experiencing is due to the attachment of a trailer (i.e., whether the vehicle is towing a trailer). The controller 3 may make such a distinction (i.e., whether the load is due to loading the vehicle 31 itself or due to the vehicle 31 towing a trailer) based on a difference in the weight or load distribution over the rear wheels 86 relative to the front wheels 90. Loading the vehicle 31 itself tends to distribute the weight or load more evenly over the front wheels 90 and rear wheels 86, while trailer towing tends to cause the rear wheels 86 to be more loaded than the front wheels 90. Therefore, the controller 3 may be programmed to distinguish between trailer loading and non-trailering loading in response to a difference between the load being detected at the rear wheels 86 and the load detected at the front wheels 90 exceeding a threshold value. Alternatively, a reverse back-up camera or sensor may be used to assess if a trailer has been attached. The reverse back-up camera or sensor may then communicate whether or not a trailer has been attached to the controller 3.

The vehicle 31 may also include an interface or display unit 102. The display unit 102 may be configured to display a distance-to-empty prediction. The distance-to-empty prediction may be stored as logic within the controller 3. The controller 3 then transmits the distance-to-empty prediction to the display unit 102, which displays the distance-to-empty prediction for the vehicle operator to observe. The distance-to-empty prediction may be based on the amount of energy stored within the battery 80 and the operating efficiency (i.e., the distance the vehicle travels per unit of energy) of the vehicle 31. More specifically, the distance-to-empty prediction may be based on the product of the amount of energy stored within the battery 80 and the operating efficiency of the vehicle 31.

It should be understood that the schematic illustrated in FIG. 2 is merely representative and is not intended to be limiting. Other configurations are contemplated without deviating from the scope of the disclosure. Fore example, the vehicle powertrain 12 may be configured to deliver power and torque to the one or both of the front wheels 90 as opposed to the rear wheels 90.

The distance-to-empty prediction algorithm that is stored within the controller 3 from the factory may be based on a computer aided engineering (CAE) model that maps out the distance-to-empty prediction relative to the weight or load on the vehicle 31. The CAE model may include two lines or curves that map out the distance-to-empty prediction relative to the weight or load. The first line or curve may represent the distance-to-empty prediction relative to a load has been placed onto the vehicle itself while the second line or curve may represent the distance-to-empty prediction relative to a load from a trailer that is being towed by the vehicle. Once the vehicle 31 has been put into use, the distance-to-empty prediction may be updated based on data from several sources. More specifically, the operating efficiency of the vehicle 31 may be updated based on recorded efficiencies from previous trips taken by the vehicle 31 itself (stored data) or may be based on recorded efficiencies from other vehicles (shared data) that has been downloaded to vehicle 31. The data from other vehicles may have been uploaded to the network 61 from the other vehicles and then downloaded to vehicle 31 to update the distance-to-empty prediction. The CAE model, the data from previous trips taken by vehicle 31, and/or the data from other vehicles may be utilized to update the current efficiency (i.e., the distance the vehicle travels per unit of energy) of the vehicle 31, which is then multiplied by the current amount of energy stored within the battery 80 to determine the current distance-to-empty prediction.

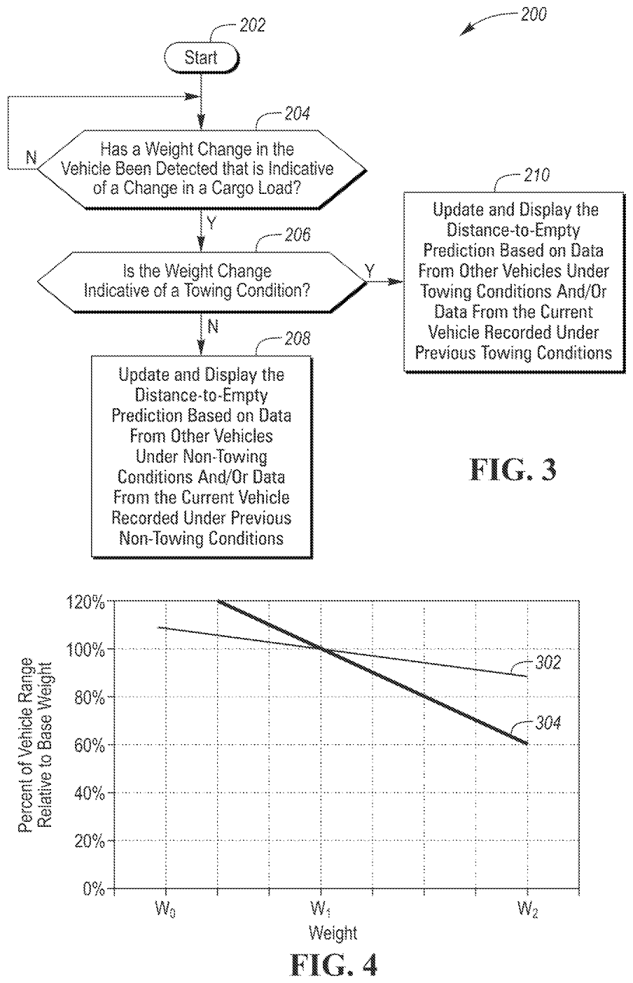

Referring to FIG. 3, a method 200 of adjusting and updating a distance-to-empty prediction of the electric vehicle 31 is illustrated. The method 200 may be stored as control logic and/or an algorithm within the controller 3. The controller 3 may implement the method 200 by controlling the various components of the vehicle 31. The method 200 is initiated at start block 202. The method 200 may be initiated at start block 202 by turning a start key or ignition of the vehicle 31 to an “on” position. The method 200 then moves on to block 204 where it is determined if a weight change in the vehicle has been detected that is indicative of a change in a cargo load on the vehicle 31. The weight change may be detected by sensors 100. Such a weight change in the vehicle 31 that is indicative of a change in the cargo load on the vehicle 31 may be based on a change in the vehicle weight from a base weight. The base weight may include the weight of the vehicle 31 plus the weight of the passengers and the fuel that the vehicle 31 is expected to normally carry. If there is not a weight change in the vehicle 31 that is indicative of a cargo load, the method 200 recycles back to the beginning of block 204.

If there is a weight change in the vehicle 31 that is indicative of a cargo load, the method 200 moves on to block 206 where it is determined if the weight change is indicative of a non-towing condition or towing condition of the vehicle 31. As previously stated, the controller 3 may determine if the loading condition of the vehicle 31 is due to a towing state as opposed to a non-towing state based on a difference between the load detected at the rear wheels 86 and the load detected at the front wheels 90 via the sensors 100 exceeding a threshold, or based on a camera or sensor detecting that a trailer has been attached to the vehicle 31. Under a towing condition, the load on the rear wheels 86 will exceed the load on the front wheels 90.

If it is determined at block 206 that the weight change in the vehicle 31 is indicative of a non-towing condition, the method 200 moves on to block 208 where the distance-to-empty prediction is updated (i.e., adjusted) and displayed based on data from the operation of other vehicles (which may be referred to as shared data) under non-towing conditions and/or data from the current vehicle 31 (which may be referred to as stored data) that was recorded while the vehicle was operating under previous non-towing conditions. The shared data and the stored data may be stored within controller 3 and/or on the network 61.

The shared data may include vehicle efficiency values (i.e., the distance the vehicle travels per unit of energy) relative to the cargo load or weight that was placed onto the other vehicles under non-towing conditions. The shared data may include the same or different weight values of the cargo load on the other vehicles under the non-towing conditions when compared to the weight value of the cargo load on vehicle 31 under the current non-towing condition. Several data points from the shared data may be utilized to generate a line or curve of estimated efficiency values relative to the weight of the cargo load under non-towing conditions that is then used to update the current distance-to-empty prediction of vehicle 31 at the current cargo load. The other vehicles may be similar to vehicle 31. For example, the other vehicles and vehicle 31 may be the same vehicle model. The shared data may be downloaded to the network 61 from the other vehicles and then uploaded to the controller 3 of vehicle 31.

The stored data may include vehicle efficiency values relative to the cargo load or weight that was placed onto the vehicle 31 under previous non-towing conditions. The stored data may be based on the same or different weight values of vehicle 31 under previous non-towing conditions when compared to the weight value of the cargo load on vehicle 31 under the current non-towing condition. Several data points from the stored data may be utilized to generate a line or curve of estimated efficiency values relative to the weight of the cargo load under non-towing conditions that is then used to update the current distance-to-empty prediction of vehicle 31. The stored data may be stored within the controller 3 of vehicle 31 and/or on the network 61. The stored data and the shared data may be combined to generate a line or curve of estimated efficiency values relative to the weight of the cargo load under non-towing conditions that is then used to update the current distance-to-empty prediction of vehicle 31. The efficiency values at a particular weight of cargo load under non-towing conditions may be based on an average of the data points of the shared data and/or stored data at such a particular weight or may be based on a line or curve fitting algorithm such as a linear least squares, linear regression, or polynomial regression function.

If it is determined at block 206 that the weight change in the vehicle 31 is indicative of a towing condition, the method 200 moves on to block 210 where the distance-to-empty prediction is updated (i.e., adjusted) and displayed based on data from the operation of other vehicles (which may be referred to as shared data) under towing conditions and/or data from the current vehicle 31 (which may be referred to as stored data) that was recorded while the vehicle was operating under previous towing conditions. The shared data and the stored data may be stored within controller 3 and/or on the network 61.

The shared data may include vehicle efficiency values (i.e., the distance the vehicle travels per unit of energy) relative to the cargo load or weight that was placed onto the other vehicles due to towing conditions. The shared data may include the same or different weight values of the cargo load on the other vehicles under the towing conditions when compared to the weight value of the cargo load on vehicle 31 under the current towing condition. Several data points from the shared data may be utilized to generate a line or curve of estimated efficiency values relative to the weight of the cargo load under towing conditions that is then used to update the current distance-to-empty prediction of vehicle 31 at the current cargo load. The other vehicles may be similar to vehicle 31. For example, the other vehicles and vehicle 31 may be the same vehicle model. The shared data may be downloaded to the network 61 from the other vehicles and then uploaded to the controller 3 of vehicle 31.

The stored data may include vehicle efficiency values relative to the cargo load or weight that was placed onto the vehicle 31 due to previous towing conditions. The stored data may be based on the same or different weight values of vehicle 31 under the previous towing conditions as compared to the weight value of the cargo load on vehicle 31 under the current towing condition. Several data points from the stored data may be utilized to generate a line or curve of estimated efficiency values relative to the weight of the cargo load under towing conditions that is then used to update the current distance-to-empty prediction of vehicle 31. The stored data may be stored within the controller 3 of vehicle 31 and/or on the network 61. The stored data and the shared data may be combined to generate a line or curve of efficiency values relative to the weight of the cargo load under towing conditions that is then used to update the current distance-to-empty prediction of vehicle 31. The efficiency values at a particular weight of cargo load under non-towing conditions may be based on an average of the data points of the shared data and/or stored data at such a particular weight or may be based on a line or curve fitting algorithm such as a linear least squares, linear regression, or polynomial regression function.

Referring to FIG. 4, a percentage adjustment to the distance-to-empty prediction relative to the weight or a load on the vehicle 31 is illustrated. The percentage adjustment is based on a percentage of the base weight, W₁, of the vehicle (described above). The percentage adjustment consists of taking a percentage of the distance-to-empty prediction of the base weight, W₁, based on the current cargo load on the vehicle 31 and displaying the percentage of the distance-to-empty prediction of the base weight, W₁, as the current distance-to-empty prediction. For example, at weight, W₂, the percent adjustment is approximately 90%. Therefore, at weight, W₂, if the distance-to-empty prediction of the base weight, W₁, is 100 miles, the current distance-to-empty prediction that is displayed will be 90 miles. Values of the percentage adjustment that are greater than 100% represent percentage adjustments that may occur when the vehicle 31 is at a weight that is less than the base weight of the vehicle 31. This may occur, for example, at weight, W₀, where there are no passengers in the vehicle 31. The percentage adjustment to the distance-to-empty prediction relative to the weight or a load on the vehicle 31 includes a first line or curve 302 that is based on data from non-towing conditions and a second line or curve 304 that is based on data from towing conditions. The first line or curve 302 and the second line or curve 304 may be initially generated based on a CAE model and then later updated with shared data (see above) or stored data (see above). It should be noted that the vehicle 31 is approximately 10-20% less efficient under towing conditions as compared to non-towing conditions, when the vehicle 31 is under the same loading conditions, which is demonstrated by the gap between the first line or curve 302 and the second line or curve 304.

The system disclosed herein for updating the distance-to-empty prediction of an electric vehicle based on the current cargo load the vehicle is carrying increases the accuracy of such a distance-to-empty prediction by increasing the source of data that is utilized to update the distance-to-empty prediction. Accuracy of a distance-to-empty prediction is essential in an electric vehicle due to the limited number of available charging stations and the need to reach such a charging station before the battery power of the electric vehicle is drained. Including an accurate distance-to-empty prediction allows an operator of the vehicle to know precisely how much travel distance is left before recharging is necessary. This allows the vehicle operator to accurately plan stops for vehicle charging without having to worry about running out of power prematurely due to an inaccurate distance-to-empty prediction.

The words used in the specification are words of description rather than limitation, and it is understood that various changes may be made without departing from the spirit and scope of the disclosure. As previously described, the features of various embodiments may be combined to form further embodiments that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. As such, embodiments described as less desirable than other embodiments or prior art implementations with respect to one or more characteristics are not outside the scope of the disclosure and may be desirable for particular applications.

What is claimed is:

1. A vehicle comprising:
an electric machine configured to propel the vehicle;
a battery configured to provide electrical power to the electric machine;
an interface; and
a controller programmed to,
display a distance-to-empty prediction on the interface, and
in response to detecting a change in a cargo load on the vehicle, adjust the distance-to-empty prediction based on shared data from other vehicles.

2. The vehicle of claim 1, wherein the distance-to-empty prediction is based on an amount of energy stored within the battery and an estimated vehicle efficiency.

3. The vehicle of claim 2, wherein the shared data includes previously recorded efficiency values of other vehicles relative to cargo load values under non-towing conditions.

4. The vehicle of claim 2, wherein the shared data includes previously recorded efficiency values of other vehicles relative to cargo load values under towing conditions.

5. The vehicle of claim 1, wherein the controller is further programmed to:
in response to detecting the change in the cargo load on the vehicle, adjust the distance-to-empty prediction based on stored data from previous loading conditions of the vehicle.

6. The vehicle of claim 5, wherein the stored data includes previously recorded efficiency values of the vehicle relative to cargo load values under non-towing conditions.

7. The vehicle of claim 5, wherein the stored data includes previously recorded efficiency values of the vehicle relative to cargo load values under towing conditions.

8. A vehicle controller comprising:
an input configured to received signals indicative of a cargo load that has been placed onto the vehicle;
an output configured to transmit a signal indicative of a distance-to-empty prediction; and
control logic programmed to, in response to detecting a change in the cargo load on the vehicle, adjust the distance-to-empty prediction based on shared data from other vehicles.

9. The controller of claim 8, wherein the distance-to-empty prediction is based on the amount of energy stored within a battery and an estimated vehicle efficiency.

10. The controller of claim 9, wherein the shared data includes previously recorded efficiency values of other vehicles relative to cargo load values under non-towing conditions.

11. The controller of claim 9, wherein the shared data includes previously recorded efficiency values of other vehicles relative to cargo load values under towing conditions.

12. The controller of claim 8, wherein the control logic is further programmed to:
in response to detecting the change in the cargo load on the vehicle, adjust the distance-to-empty prediction based on stored data from previous loading conditions of the vehicle.

13. The controller of claim 12, wherein the stored data includes previously recorded efficiency values of the vehicle relative to cargo load values under non-towing conditions.

14. The controller of claim 12, wherein the stored data includes previously recorded efficiency values of the vehicle relative to cargo load values under towing conditions.

15. A method of adjusting a distance-to-empty prediction of an electric vehicle comprising:
displaying a distance-to-empty prediction on an interface; and
in response to detecting a change in a cargo load on the vehicle, adjusting the distance-to-empty prediction based on shared data from other vehicles.

16. The method of claim 15, wherein the distance-to-empty prediction is based on the amount of energy stored within a battery and an estimated vehicle efficiency.

17. The method of claim 16, wherein the shared data includes previously recorded efficiency values of other vehicles relative to cargo load values under non-towing conditions.

18. The method of claim 16, wherein the shared data includes previously recorded efficiency values of other vehicles relative to cargo load values under towing conditions.

19. The method of claim 15 further comprising:
in response to detecting the change in the cargo load on the vehicle, adjust the distance-to-empty prediction based on stored data from previous loading conditions of the vehicle.

20. The method of claim 19, wherein the stored data includes previously recorded efficiency values of the vehicle relative to specific cargo load values.
